(19) United States
(12) Patent Application Publication
(10) Pub. No.: US 2024/0385366 A1
(43) Pub. Date: Nov. 21, 2024

(54) OPTICAL WAVEGUIDE DEVICE

(71) Applicant: SHINKO ELECTRIC INDUSTRIES CO., LTD., Nagano (JP)

(72) Inventors: Kazunao YAMAMOTO, Nagano (JP); Hisashi KANEDA, Nagano (JP)

(21) Appl. No.: 18/663,665

(22) Filed: May 14, 2024

(30) Foreign Application Priority Data
May 17, 2023 (JP) 2023-081305

(51) Int. Cl. G02B 6/12; G02B 6/42

(52) U.S. Cl. CPC G02B 6/12; G02B 6/4239; G02B 6/4274; G02B 2006/12061

(57) ABSTRACT

An optical waveguide device includes an interconnect substrate, a first cladding layer disposed on the interconnect substrate, a core layer disposed on the first cladding layer, a second cladding layer disposed on the first cladding layer and selectively covering the core layer, and one or more elevated supports disposed on the first cladding layer and apart from the core layer, wherein one longitudinal-direction end of the core layer and the elevated supports are situated in a component mounting region exposed from the second cladding layer, and wherein the elevated supports are made of a same material as the core layer and have a same thickness as the core layer.

### CROSS-REFERENCE TO RELATED APPLICATIONS

The present application is based on and claims priority to Japanese Patent Application No. 2023-081305 filed on May 17, 2023, with the Japanese Patent Office, the entire contents of which are incorporated herein by reference.

### FIELD

The disclosures herein relate to optical waveguide devices.

### BACKGROUND

An optical waveguide device having silicon photonic chips and optical waveguides is used to transmit and receive signals in a data center or the like where various computers and data communication apparatuses are installed. In such an optical waveguide device, the core layer of an optical waveguide and the silicon waveguide of a silicon photonic chip are optically coupled to each other.

In the optical waveguide device as described above, it is challenging to align heights of the core layer of an optical waveguide and the silicon waveguide of a silicon photonic chip. Because of this, the silicon photonic chip may sometimes be mounted at an angle to the upper surface of the core layer.

Accordingly, there may be a need to provide an optical waveguide device which reduces the risk of a silicon photonic chip being mounted at an angle to the upper surface of a core layer.

### RELATED-ART DOCUMENT

### Patent Document

[Patent Document 1] Japanese Laid-open Patent Publication No. 2018-200333

### SUMMARY

According to an aspect of the embodiment, an optical waveguide device includes an interconnect substrate, a first cladding layer disposed on the interconnect substrate, a core layer disposed on the first cladding layer, a second cladding layer disposed on the first cladding layer and selectively covering the core layer, and one or more elevated supports disposed on the first cladding layer and apart from the core layer, wherein one longitudinal-direction end of the core layer and the elevated supports are situated in a component mounting region exposed from the second cladding layer, and wherein the elevated supports are made of a same material as the core layer and have a same thickness as the core layer.

The object and advantages of the embodiment will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIGS. 1A and 1B are drawings illustrating an optical waveguide device according to a first embodiment;

FIG. 2 is a drawing illustrating a manufacturing process of the optical waveguide device according to the first embodiment;

FIGS. 3A through 3D are drawings illustrating a manufacturing process of the optical waveguide device according to the first embodiment;

FIGS. 4A and 4B are drawings illustrating an optical waveguide device according to a second embodiment; and

FIGS. 5A through 5C are drawings illustrating a manufacturing process of the optical waveguide device according to the second embodiment.

### DESCRIPTION OF EMBODIMENTS

In the following, the embodiment for implementing the invention will be described with reference to the drawings. In each drawing, the same component parts are denoted by the same reference numerals, and duplicate descriptions may be omitted.

### First Embodiment

### [Optical Waveguide Device]

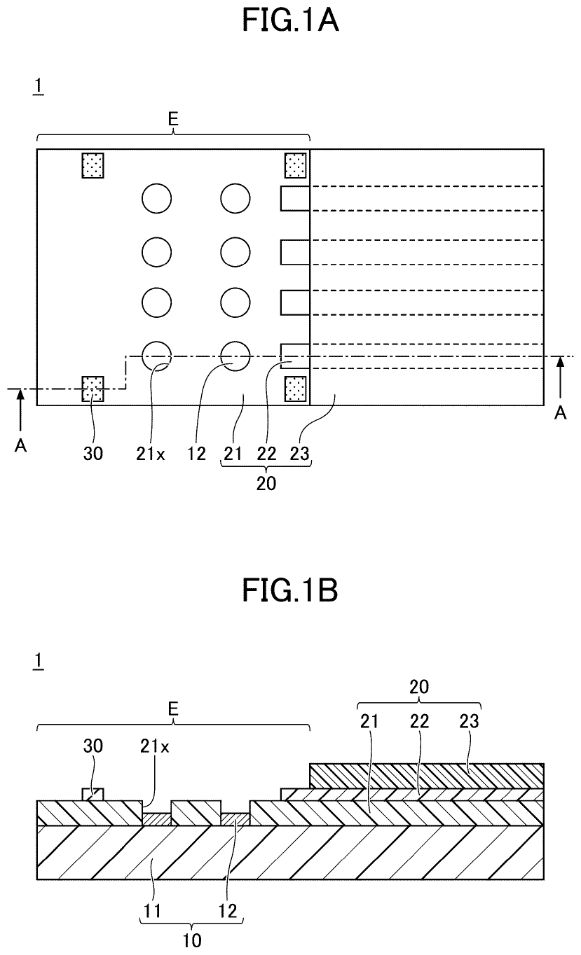

FIGS. 1A and 1B are drawings illustrating an optical waveguide device according to a first embodiment, FIG. 1A is a plan view, and FIG. 1B is a cross-sectional view taken along the line A-A in FIG. 1A.

Referring to FIGS. 1A and 1B, an optical waveguide device 1 includes an interconnect substrate 10, an optical waveguide 20, and elevated supports 30. In FIG. 1A, the elevated supports 30 are illustrated in dot shading for the sake of convenience.

The interconnect substrate 10 includes a base 11 and electrodes 12. The base 11 is made of an insulating resin material such as epoxy resin or polyimide resin, for example. The base 11 may contain a reinforcing member such as a glass cloth. The base 11 may have a laminated structure comprised of one or more insulating layers and one or more interconnect layers. The electrodes 12 may be used as connection terminals. The electrodes 12 may be made of, for example, copper. A surface treatment layer such as a metal layer may be formed on the electrodes 12.

The interconnect substrate 10 may be a rigid substrate with high rigidity or a flexible substrate with low rigidity. The interconnect substrate 10 may be, for example, a build-up substrate, a silicon substrate, a ceramic substrate, or the like.

The optical waveguide 20 includes a first cladding layer 21, a core layer 22, and a second cladding layer 23.

The first cladding layer 21 is disposed on the interconnect substrate 10. The thickness of the first cladding layer 21 may be, for example, about 10 μm to 30 μm. The refractive index of the first cladding layer 21 may be, for example, about 1.5. The first cladding layer 21 may be made of a photosensitive resin such as a polyimide resin, an acrylic resin, an epoxy resin, a polyolefin resin, a polynorbornene resin, or the like.

The core layer 22 is disposed on the first cladding layer 21. The width of each strip of the core layer 22 may be, for example, about 5 μm to 10 μm. The thickness of the core layer 22 may be, for example, about 5 μm to 10 μm. The refractive index of the core layer 22 is higher than the refractive indexes of the first cladding layer 21 and the second cladding layer 23, and may be about 1.6, for example. The core layer 22 may be made of, for example, a material selected as appropriate from those listed as example materials for the first cladding layer 21.

Although the illustrated structure of the optical waveguide device 1 is such that four strips of the core layer 22 are arranged side by side at predetermined intervals, the structure may have a plurality of strips of the core layer 22 arranged side by side at predetermined intervals, or may have only one strip of the core layer 22. Each strip of the core layer 22 may not have to be formed in a straight line, and may include a curved portion. The distance between each pair of adjacent strips of the core layer 22 may or may not be constant.

The second cladding layer 23 is disposed on the first cladding layer 21 and selectively covers the core layer 22. The thickness of the second cladding layer 23 may be, for example, about 10 μm to 30 μm. The refractive index of the second cladding layer 23 may be, for example, about 1.5. The second cladding layer 23 is a cured photosensitive resin. The second cladding layer 23 may be made of, for example, a material selected as appropriate from those listed as example materials for the first cladding layer 21.

One or more elevated supports 30 are formed on the first cladding layer 21 and positioned at a distance from the core layer 22. In the example illustrated in FIG. 1A, four elevated supports 30 are formed on the first cladding layer 21. Each elevated support 30 is made of the same material as the core layer 22 and has the same thickness as the core layer 22. This means that the elevated supports 30 and the core layer 22 have the same thickness according to design, and the thicknesses of these two are regarded as the same even when the thicknesses vary with errors comparable to manufacturing variation caused by the photolithography method.

The optical waveguide device 1 includes a component mounting region E not covered with the second cladding layer 23. One longitudinal-direction end of the strips of the core layer 22 and the elevated supports 30 are situated in the component mounting region E. The electrodes 12 of the interconnect substrate 10 are disposed in the component mounting region E. In the component mounting region E, the electrodes 12 are exposed in openings 21x provided in the first cladding layer 21.

As will be described later, the component mounting region E is a region where a silicon photonic chip is to be mounted. The silicon photonic chip will be disposed at one longitudinal-direction end of the strips of the core layer 22 and on the elevated supports 30 in the component mounting region E. The core layer 22 and the elevated supports 30 are disposed on the same plane (i.e., the upper surface of the first cladding layer 21) and have the same thickness, which serves to reduce the risk of mounting the silicon photonic chip at an angle to the upper surface of the core layer 22.

Since the silicon photonic chip is disposed at one longitudinal-direction end of the strips of the core layer 22 and on the elevated supports 30, the stress from the silicon photonic chip is dispersed between the core layer 22 and the elevated supports 30. This arrangement thus reduces the risk of the core layer 22 being destroyed by the stress from the silicon photonic chip.

### [Method of Making Optical Waveguide Device]

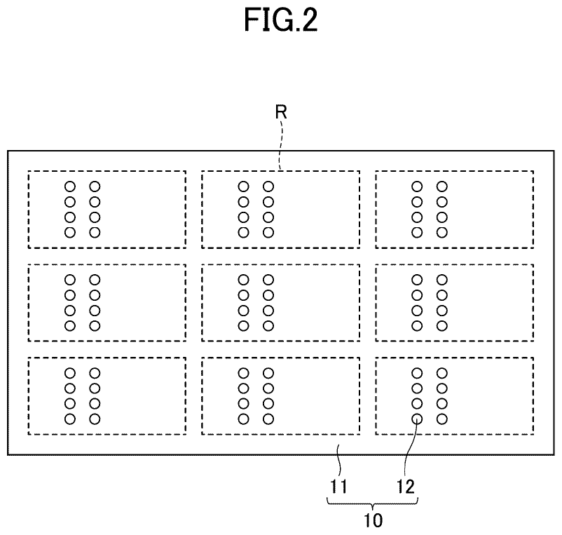

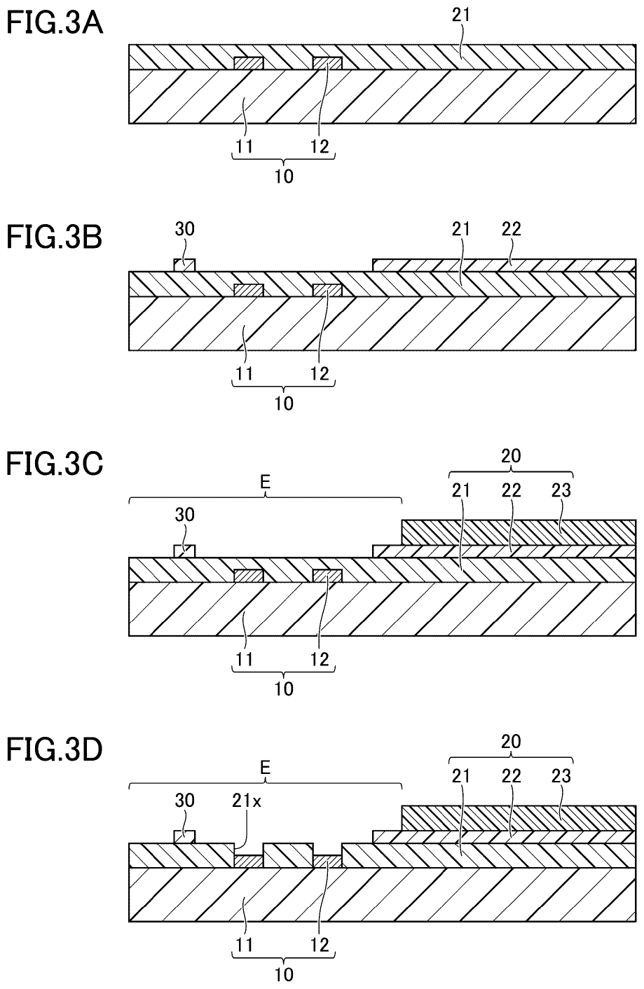

In the following, a method of making the optical waveguide device 1 will be described. FIG. 2 and FIGS. 3A through 3D are drawings illustrating a manufacturing process of the optical waveguide device according to the first embodiment.

In the method of making the optical waveguide device according to the first embodiment, an interconnect substrate 10 having a base 11 and electrodes 12 as illustrated in FIG. 2 is prepared. The interconnect substrate 10 is, for example, a large substrate for providing multiple devices having a plurality of product regions R defined therein, and will be cut along the outer perimeter of each of the product regions R to obtain individual optical waveguide devices. The interconnect substrate 10 may be a rigid substrate with high rigidity or a flexible substrate with low rigidity. The interconnect substrate 10 may be, for example, a build-up substrate, a silicon substrate, a ceramic substrate, or the like.

FIGS. 3A through 3D illustrate a cross section corresponding to FIG. 1B in one product region R. In the step illustrated in FIG. 3A, a first cladding layer 21 is formed on the interconnect substrate 10. The first cladding layer 21 is made by irradiating a photosensitive resin with ultraviolet light and then curing the photosensitive resin by heat treatment at a temperature of 150° C. to 200° C.

The first cladding layer 21 is disposed throughout the entirety of the upper surface of the interconnect substrate 10 in which the plurality of product regions R are defined as illustrated in FIG. 2. When the outer shape of the first cladding layer 21 is to be adjusted by patterning, the photosensitive resin is irradiated with ultraviolet light through a photomask and developed to produce the first cladding layer 21.

A method of placing a photosensitive resin may include attaching a resin sheet or applying a liquid resin. The thickness of the first cladding layer 21 is, for example, about 10 μm to 30 μm.

In the step illustrated in FIG. 3B, a plurality of strips of a core layer 22 and elevated supports 30 are formed on the first cladding layer 21. Specifically, a photosensitive resin for forming the core layer 22 and the elevated supports 30 is placed on the first cladding layer 21, and, then, the photosensitive resin is irradiated with ultraviolet light through a photomask, followed by development and then curing the photosensitive resin by heat treatment at a temperature of about 150° C. to 200° C.

With the above-noted arrangement, a plurality of strips of the core layer 22 are arranged side by side as strip patterns on the first cladding layer 21. The elevated supports 30 are formed on the first cladding layer 21 at a distance from the core layer 22. The width of each strip of the core layer 22 is set to, for example, 5 μm to 10 μm, and the thickness of the core layer 22 is set to, for example, 5 μm to 10 μm. In the present embodiment, each strip of the core layer 22 has a small cross-sectional area in order to provide a single-mode optical waveguide. The thickness of the elevated supports 30 is set to be, for example, 5 μm to 10 μm, similar to the thickness of the core layer 22. Being positioned away from the core layer 22, the elevated supports 30 may be allowed to have any plane shape suitable to required specifications. Further, when positioned apart from the core layer 22, the elevated supports 30 may be provided in any number that is appropriate for the required specifications.

The plurality of strips of the core layer 22 are laterally extended to stretch over each product region R and go across the gaps between the product regions R previously described in connection with FIG. 2.

In the step illustrated in FIG. 3C, a second cladding layer 23 is formed on the first cladding layer 21. The second cladding layer 23 is made by irradiating a photosensitive resin with ultraviolet light and then curing the photosensitive resin by heat treatment at a temperature of 150° C. to 200° C. The second cladding layer 23 is structured to have a flat upper surface while covering the upper surfaces and the side surfaces of the strips of the core layer 22.

The photosensitive resin to become the second cladding layer 23 is disposed throughout the entirety of the upper surface of the interconnect substrate 10 where the plurality of product regions R are defined as illustrated in FIG. 2. Thereafter, the photosensitive is resin irradiated with ultraviolet light through a photomask and then developed, which produces the second cladding layer 23 selectively covering the core layer 22 and exposing the elevated supports 30. The region exposed from the second cladding layer 23 becomes the component mounting region E. One longitudinal-direction end of the strips of the core layer 22 and all the elevated supports 30 are situated in the component mounting region E.

By this step, the optical waveguide 20 is constructed with the first cladding layer 21, the core layer 22, and the second cladding layer 23. In the optical waveguide 20, the refractive index of the core layer 22 is set higher than the refractive indexes of the first cladding layer 21 and the second cladding layer 23.

In the illustrated in step FIG. 3D, openings 21x for exposing the electrodes 12 are formed through the first cladding layer 21. The electrodes 12 are exposed in the component mounting region E. The openings 21x may be formed by, for example, laser machining. The openings 21x may alternatively be formed by photolithography in the step illustrated in FIG. 3A.

After the step illustrated in FIG. 3D, the second cladding layer 23, the core layer 22, the first cladding layer 21, and the interconnect substrate 10 are cut and singulated along the outer perimeter of each product region R by a rotary blade of a cutting device. This completes each of the optical waveguide devices 1 illustrated in FIG. 1 in its final form.

### Second Embodiment

A second embodiment is directed to an example of an optical waveguide device optically coupled with a silicon waveguide. With respect to the second embodiment, a description of the same elements as those of the previously described embodiment may be omitted.

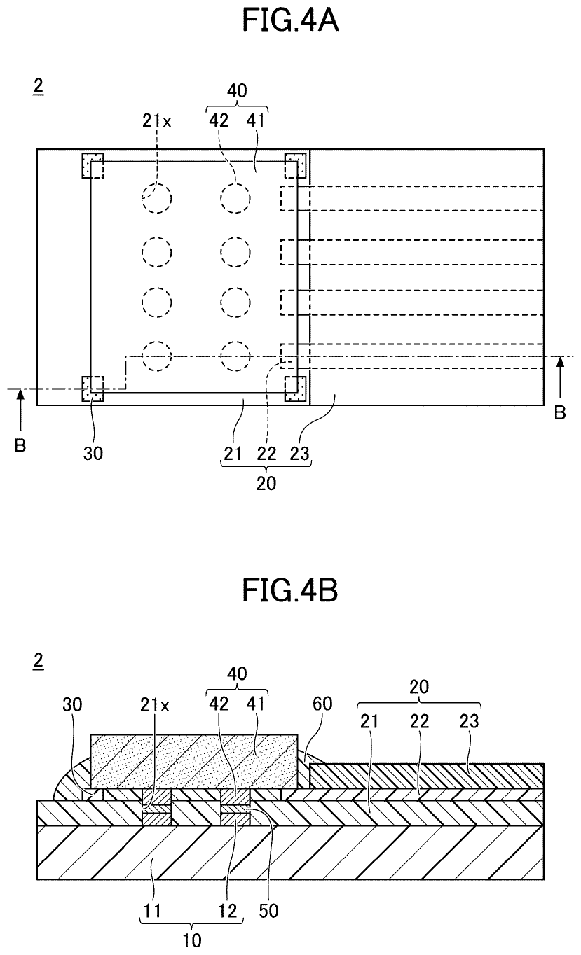

FIGS. 4A and 4B are drawings illustrating an optical waveguide device according to the second embodiment. FIG. 4A is a plan view, and FIG. 4B is a cross-sectional view taken along the line B-B in FIG. 4A. In FIG. 4A, the underfill resin 60 illustrated in FIG. 4B is omitted from illustration.

Referring to FIGS. 4A and 4B, an optical waveguide device 2 differs from the optical waveguide device 1 in that a silicon photonic chip 40 is mounted in the component mounting region E.

The silicon photonic chip 40 includes a silicon substrate 41 and electrodes 42 provided on one side of the silicon substrate 41. A silicon waveguide is provided on the one side of the silicon substrate 41. The silicon waveguide is a fine optical waveguide incorporated into a silicon chip, and is used in the silicon photonic technology that integrates optical circuits and the like in a silicon chip.

The thickness of the silicon substrate 41 is, for example, about 100 μm to 800 μm. The silicon waveguide may, for example, be provided on a protective film provided on the silicon substrate 41. The protective film may, for example, be made of SiO₂, SiO_{X}, or the like. The thickness of the protective film is, for example, about 2 μm to 6 μm. The silicon waveguide may be embedded in the silicon substrate 41. The electrodes 42 may be made of, for example, copper.

The silicon photonic chip 40 is arranged in the component mounting region E with the silicon waveguide facing the core layer 22. The silicon photonic chip 40 is provided such that the lower surface of the silicon substrate 41 is arranged in contact with at least a part of the one end of the strips of the core layer 22 and at least a part of the elevated supports 30, with the silicon waveguide being optically coupled with the core layer 22. When the silicon waveguide projects from the silicon substrate 41 toward the core layer 22, part or all of the silicon waveguide may be embedded in the core layer 22. A portion of the silicon waveguide, which portion is optically coupled with the core layer 22, may be tapered.

The electrodes 42 of the silicon photonic chip 40 are electrically connected to the electrodes 12 of the interconnect substrate 10. The electrodes 42 and the electrodes 12 may be electrically connected through bonding members 50 such as solder, for example. Alternatively, the electrodes 42 and the electrodes 12 may be directly connected through metallic bonding, for example.

Preferably, at least one of the elevated supports 30 is disposed on the opposite side from one longitudinal-direction end of the strips of the core layer 22 across the electrodes 12 in a plan view (as viewed in the direction normal to the upper surface of the first cladding layer 21). With such an arrangement, there is a long distance between the at least one of the elevated supports 30 and the one longitudinal-direction end of the strips of the core layer 22, thereby reducing the risk of mounting the silicon photonic chip 40 at an angle to the upper surface of the core layer 22. Satisfactory optical coupling may thus be achieved between the silicon photonic chip 40 and the core layer 22.

The silicon substrate 41 of the silicon photonic chip 40 has, for example, a rectangular shape with four corners on a surface facing the first cladding layer 21. In this case, one elevated support 30 is preferably disposed in contact with each of at least two corners on the opposite side across the electrodes 12 from one longitudinal-direction end of the strips of the core layer 22 in a plan view. Such an arrangement may further reduce the possibility that the silicon photonic chip 40 is mounted at an angle to the upper surface of the core layer 22. As in the example illustrated in FIGS. 4A and 4B, the elevated supports 30 may be disposed in one-to-one correspondence with, and in contact with, the four respective corners. Such an arrangement may further reduce the possibility that the silicon photonic chip 40 is mounted at an angle to the upper surface of the core layer 22.

Preferably, at least one of the elevated supports 30 has, in plan view, a portion overlapping the silicon photonic chip 40 and a portion protruding from the silicon photonic chip 40. All of the elevated supports 30 may have, in plan view, a portion overlapping the silicon photonic chip 40 and a portion protruding from the silicon photonic chip 40. The arrangement in which the elevated supports 30 have a portion extending from the silicon photonic chip 40 enables a surface of the silicon substrate 41, which surface faces the first cladding layer 21, to be supported at the outermost part thereof. This arrangement may thus further reduce the possibility that the silicon photonic chip 40 is mounted at angle to the upper surface of the core layer 22.

In the optical waveguide device 2, since the stress from the silicon photonic chip 40 is dispersed among the core layer 22 and the elevated supports 30, the possibility that the core layer 22 is destroyed by the stress from the silicon photonic chip 40 may be reduced.

An underfill resin 60 may be disposed between the first cladding layer 21 and the silicon substrate 41 of the silicon photonic chip 40. The underfill resin 60 preferably covers at least the periphery of the electrodes 42. The underfill resin 60 may cover part or all of the side surface of the silicon substrate 41. The provision of the underfill resin 60 serves to improve the reliability of connection between the interconnect substrate 10 and the silicon photonic chip 40.

In the optical waveguide device 2, an end face (the right end face in FIGS. 4A and 4B) of the core layer 22, which end face is opposite from the side where the silicon photonic chip 40 and the core layer 22 are optically coupled to each other, may be connected to a connector or the like (not illustrated). On the interconnect substrate 10, a semiconductor device or the like may be mounted on the side (the left side in FIGS. 4A and 4B) opposite to the side where the silicon photonic chip 40 and the core layer 22 are optically coupled to each other.

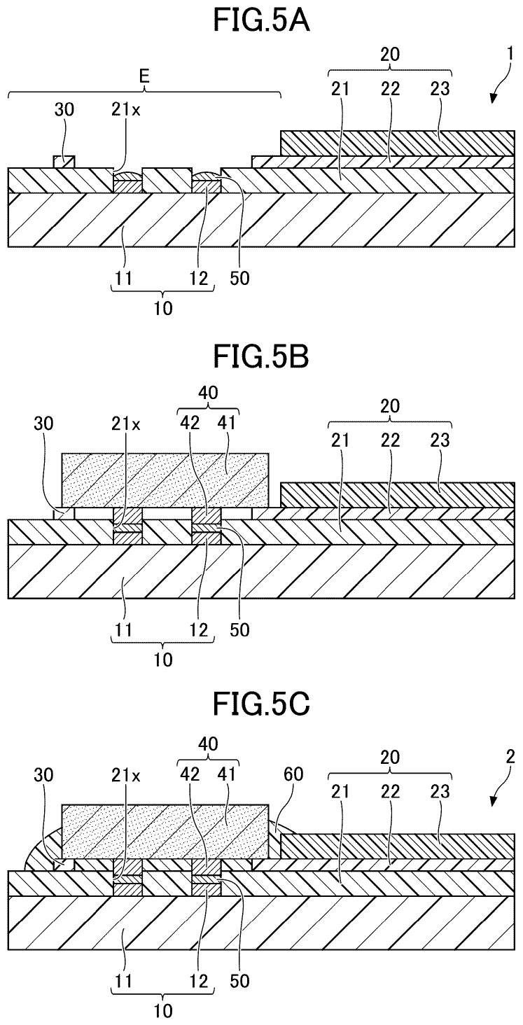

FIGS. 5A through 5C are drawings illustrating a manufacturing process of the optical waveguide device according to the second embodiment. In order to manufacture the optical waveguide device 2, the optical waveguide device 1 described in the first embodiment is prepared in the step illustrated in FIG. 5A. Subsequently, bonding members 50 such as solder are arranged on the electrodes 12 exposed in the openings 21x.

In the step illustrated in FIG. 5B, a silicon photonic chip 40 is disposed in the component mounting region E. At this time, alignment is performed by, for example, an alignment method using an alignment mark used for mounting a semiconductor device or the like, such that the electrodes 42 are positioned on the bonding members 50 and the silicon waveguide is positioned on the core layer 22. Thereafter, the bonding members 50 are melted and then solidified, so that the electrodes 12 and the electrodes 42 are joined through the bonding members 50. The silicon waveguide of the silicon photonic chip 40 is optically coupled to the core layer 22.

In this step, the silicon photonic chip 40 is disposed on one longitudinal-direction end of the strips of the core layer 22 and on the elevated supports 30 in the component mounting region E. The arrangement in which the core layer 22 and the elevated supports 30 are disposed on the same plane (i.e., the upper surface of the first cladding layer 21) and have the same thickness serves to reduce the possibility that the silicon photonic chip 40 is mounted at an angle to the upper surface of the core layer 22.

In the step illustrated in FIG. 5C, an underfill resin 60 is disposed between the first cladding layer 21 and the silicon photonic chip 40 according to need. An insulating resin such as an epoxy resin, for example, may be used as a material of the underfill resin 60. A resin material having high flowability is preferably used as a material of the underfill resin 60. The high flowability makes it easy to fill the underfill resin 60 between the first cladding layer 21 and the silicon photonic chip 40. Curing the underfill resin 60 completes the optical waveguide device 2 in its final form.

According to at least one embodiment, it is possible to provide an optical waveguide device which reduces the risk of a silicon photonic chip being mounted at an angle to the upper surface of a core layer.

All examples and conditional language recited herein are intended for pedagogical purposes to aid the reader in understanding the invention and the concepts contributed by the inventor to furthering the art, and are to be construed as being limitation to such specifically recited without examples and conditions, nor does the organization of such examples in the specification relate to a showing of the superiority and inferiority of the invention. Although the embodiment(s) of the present inventions have been described in detail, it should be understood that the changes, various substitutions, and alterations could be made hereto without departing from the spirit and scope of the invention.

What is claimed is:

1. An optical waveguide device, comprising:
an interconnect substrate;
a first cladding layer disposed on the interconnect substrate;
a core layer disposed on the first cladding layer;
a second cladding layer disposed on the first cladding layer and selectively covering the core layer; and
one or more elevated supports disposed on the first cladding layer and apart from the core layer,
wherein one longitudinal-direction end of the core layer and the elevated supports are situated in a component mounting region exposed from the second cladding layer, and
wherein the elevated supports are made of a same material as the core layer and have a same thickness as the core layer.

2. The optical waveguide device as claimed in claim 1, wherein the interconnect substrate has an electrode serving as a connection terminal in the component mounting region, and the electrode is exposed in an opening provided in the first cladding layer.

3. The optical waveguide device as claimed in claim 2, wherein at least one of the elevated supports is disposed in plan view on an opposite side from the one longitudinal-direction end of the core layer across the electrode.

4. An optical waveguide device comprising:
an interconnect substrate;
a first cladding layer disposed on the interconnect substrate;
a core layer disposed on the first cladding layer;
a second cladding layer disposed on the first cladding layer and selectively covering the core layer;
one or more elevated supports disposed on the first cladding layer and apart from the core layer; and
a silicon photonic chip,
wherein one longitudinal-direction end of the core layer and the elevated supports are disposed in a component mounting region exposed from the second cladding layer,
wherein the elevated supports are made of a same material as the core layer and has a same thickness as the core layer, and
wherein the silicon photonic chip is arranged in the component mounting region in contact with the one longitudinal-direction end of the core layer and at least a part of each of the elevated supports, and is optically coupled to the core layer.

5. The optical waveguide device as claimed in claim 4, wherein the interconnect substrate has an electrode serving as a connection terminal in the component mounting region, and the electrode of the interconnect substrate is exposed in an opening provided in the first cladding layer, and
wherein an electrode of the silicon photonic chip is electrically connected to the electrode of the interconnect substrate.

6. The optical waveguide device as claimed in claim 5, wherein in plan view, at least one of the elevated supports is situated on an opposite side from the one longitudinal-direction end of the core layer across the electrode of the interconnect substrate.

7. The optical waveguide device as claimed in claim 6, wherein the silicon photonic chip has four corners on a surface thereof facing the first cladding layer, and the elevated supports are arranged in one-to-one correspondence with, and in contact with, at least two of the corners.

8. The optical waveguide device as claimed in claim 4, wherein at least one of the elevated supports has a portion overlapping the silicon photonic chip and a portion protruding from the silicon photonic chip in plan view.

9. The optical waveguide device as claimed in claim 5, wherein at least one of the elevated supports has a portion overlapping the silicon photonic chip and a portion protruding from the silicon photonic chip in plan view.

10. The optical waveguide device as claimed in claim 6, wherein at least one of the elevated supports has a portion overlapping the silicon photonic chip and a portion protruding from the silicon photonic chip in plan view.

11. The optical waveguide device as claimed in claim 7, wherein at least one of the elevated supports has a portion overlapping the silicon photonic chip and a portion protruding from the silicon photonic chip in plan view.

12. The optical waveguide device according to claim 4, further comprising an underfill resin disposed between the first cladding layer and the silicon photonic chip.

13. The optical waveguide device according to claim 5, further comprising an underfill resin disposed between the first cladding layer and the silicon photonic chip.

14. The optical waveguide device according to claim 6, further comprising an underfill resin disposed between the first cladding layer and the silicon photonic chip.

15. The optical waveguide device according to claim 7, further comprising an underfill resin disposed between the first cladding layer and the silicon photonic chip.
